(19) United States
(12) Patent Application Publication
(10) Pub. No.: US 2011/0179933 A1
(43) Pub. Date: Jul. 28, 2011

(54) AUTOMATIC FLANGE SURFACE MACHINING APPARATUS

(76) Inventors: Sang Gulk Ahn, Ulsan (KR); Seong Won Lee, Ulsan (KR)

(21) Appl. No.: 13/122,411

(22) PCT Filed: Sep. 29, 2009
(86) PCT No.: PCT/KR09/05569

§ 371 Date: Apr. 2, 2011

(30) Foreign Application Priority Data
Oct. 2, 2008 (KR) 10-2008-0097240

(51) Int. Cl. B23D 21/00

(52) U.S. Cl. 83/745

(57) ABSTRACT

Disclosed is an automatic flange surface machining apparatus for machining a flange surface. The automatic flange surface machining apparatus of the present invention comprises a flange fixing unit fixed at the inner surface of a pipe formed on a flange, a shaft secured onto the flange fixing unit, a main body which has a linear toolbar guiding path formed at one side thereof, and which has a guide protrusion for providing a space that communicates with the toolbar guiding path to enable the penetration of the shaft, and which is rotatably coupled to the shaft that has penetrated the space, a toolbar installed in the toolbar guiding path such that the toolbar moves along the toolbar guiding path, a toolbar moving means arranged in the main body to move the toolbar, an inner gear coupled onto the main body, a rotating motor base installed on the inner gear, and fixed at the shaft, an inner gear driving means coupled to the rotating motor base to rotate the inner gear, and a flange surface machining unit installed on one side of the toolbar to machine the flange surface.

### TECHNICAL FIELD

The present invention relates to an automatic flange surface-machining apparatus, in particular, an automatic flange surface-machining apparatus which can machine flange surface using driving means such as motors and the like.

### BACKGROUND ART

The flange needs to be serration-machined on its surface contacting with gasket according to the environment in which the flange is used, and in such a maching work of a prior art, the serration is machined by fixing a chuck in a pipe and the like formed with the flange and using a cutting device equipped with a bite rotated around a center of the chuck by means of air pressure over the chuck.

Furthermore, in such a device, the distance from the center of the chuck to the bite is manually adjusted using several gears.

However, such a prior serration-machining apparatus is pneumatically driven, therefore in addition to a main body of the serration-machining apparatus, a compressor for supplying air pressure to the main body of the serration-machining apparatus is indispensably needed, and weight of the whole apparatus is increased and its size becomes excessively large due to need for the compressor.

Furthermore, the prior serration-machining apparatus has a disadvantage that since the bite is rotated in one direction when the serration is machined and the rotational speed is controlled through pneumatic pressure and the number of stages of the gears mounted in the main body, more precise control is not possible.

The above-mentioned fact causes a problem that roughness (roughness degree of a surface) of the serration machined can not be uniform.

In addition, another problem is present that since the compressor generates pneumatic pressure which is not uniform, vibration is generated in the rotated bite due to un-uniformity of the pneumatic pressure, accordingly the bite is moved, thus the roughness of the serration becomes un-uniform.

### DISCLOSURE OF THE INVENTION

### Problem to be Solved by the Invention

The present invention has been devised to solve the above-mentioned problems, and its object is to provide an automatic flange surface-machining apparatus in which the position of the bite is adjusted by means of motors and which can machine serration of the flange surface by rotating the bite.

### Means for Solving the Problems

Constructions of an automatic flange surface-machining apparatus according to an example of the present invention comprise a flange-fixing part fixed on the inner circumferential surface of a pipe formed on a flange; a shaft coupled with upper part of the flange-fixing part; a main body in which is installed a guide protrusion for providing a linear toolbar-guiding path at one side thereof and a space communicating with the toolbar-guiding path and penetrated by the shaft, and which is rotatably coupled with the shaft penetrating the space; a toolbar installed between the toolbar-guiding path so as to be moved along the toolbar-guiding path; a toolbar-feeding means installed in the main body to feed the toolbar; an internal gear coupled over the main body; a rotating motor base installed over the internal gear and fixed to the shaft; an internal gear-driving means coupled with the rotating motor base to rotate the internal gear; and a flange surface-machining part installed on one side of the toolbar to machine the flange surface.

An automatic flange surface-machining apparatus according to another example of the present invention comprise a flange-fixing part fixed on the internal surface of a pipe formed on a flange; a shaft coupled with upper part of the flange-fixing part; a main body in which is installed a guide protrusion for providing a linear toolbar-guiding path at one side thereof and a space communicating with the toolbar-guiding path and penetrated by the shaft, and which is rotatably coupled with the shaft penetrating the space; a toolbar supported between the toolbar-guiding path; an internal gear coupled over the main body; a rotating motor base installed over the internal gear and fixed to the shaft; an internal gear-driving means coupled with the rotating motor base to rotate the internal gear; and a flange surface-machining part installed on one side of the toolbar so as to be linearly movable to machine the flange surface.

### Effects of the Invention

In the automatic flange surface-machining apparatus constructed as above according to the present invention, the bite for machining serration on the flange surface is horizontally moved in the main body and rotated and is driven up-downward according to depth of the serration, therefore uniform roughness of the serration can be obtained, and the serration can be machined with accurate position and rotational speed by connecting the controller to each of the driving parts, and the whole size and weight of the apparatus can be reduced by performing horizontal, up-downward and rotational movement by means of motors.

### BRIEF DESCRIPTION OF THE DRAWING

FIG. 1 is a exploded perspective view illustrating an automatic flange surface-machining apparatus according to a preferred example of the present invention.

FIG. 2 is a partially cut-out perspective view illustrating coupling relations of a main body and a toolbar of the automatic flange surface-machining apparatus shown in FIG. 1.

FIG. 3 is a exploded perspective view illustrating a flange surface-machining part of the automatic flange surface-machining apparatus shown in FIG. 1.

FIG. 4 is a cross-sectional view illustrating a flange-fixing part shown in FIG. 1.

FIG. 5 is a view illustrating conditions for using the automatic flange surface-machining apparatus shown in FIG. 1.

FIG. 6 is a perspective view illustrating a feeding motor-receiving part coupled with the toolbar according to another example of the present invention.

FIG. 7 is a exploded perspective view of FIG. 6.

FIG. 8 is a view illustrating conditions for using the automatic flange surface-machining apparatus according to the another example of the present invention.

### LISTS OF REFERENCE NUMERALS IN THE DRAWINGS

1, 1′: automatic flange surface-machining apparatus 3: flange
3a: flange surface 5: pipe
7: serration 10: flange-fixing part
12: chuck body 15: level block
17: flange-fixing bolt 20: shaft
22: slip ring 30: main body
32: plane plate 36: guide protrusion
37: space 38: toolbar-guiding path
40: toolbar 52: rack gear
54: rack gear-driving part 56: feeding motor
60: internal gear 65: cover
70: rotating motor base 73: fixing means
80: internal gear-driving means 82: rotational gear
84: rotating motor reducer 86: rotating motor
90: flange surface-machining part 92: toolbar-coupling part
94: bite-fixing part 96: bite-fixing part-feeding means
92′: feeding shaft-coupling part
500: feeding motor-receiving part 504: supporting part
506: guide rail 510: first bracket
520: second bracket 521: driving pulley
522: follower pulley 523: timing belt
530: feeding shaft
921: right-leftward feeding block 922: guide part

### BEST MODE FOR CARRYING OUT THE INVENTION

Hereinbelow, preferred examples of the automatic flange surface-machining apparatus according to the present invention will be described with reference to the attached drawings. In this regard, thickness of lines or size of constituents etc. illustrated in the drawings may be illustrated by exaggeration for the sake of clarity and convenience of explanation.

Furthermore, the following examples do not limit the scope of claims of the present invention, rather are only exemplary items of the constituents presented in the claims of the present invention, and within the scope of the claims are also included examples which are included in technical concepts shown in the whole specification of the present invention and comprise constituents which can be substituted as equivalents of the constituents in the claims.

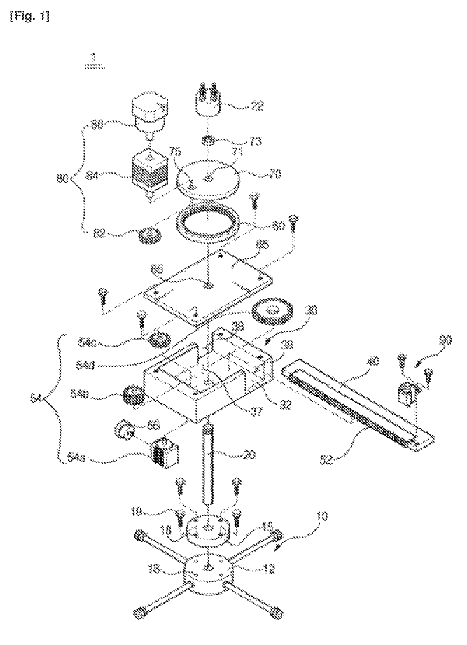

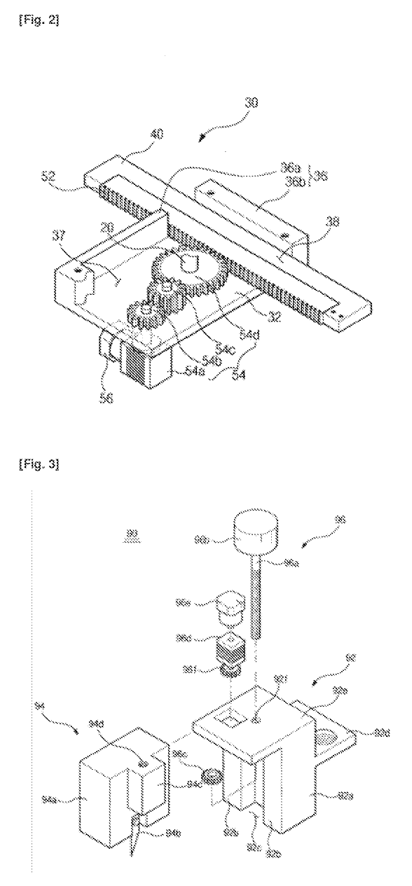

FIG. 1 is a exploded perspective view illustrating an automatic flange surface-machining apparatus (1) according to a preferred example of the present invention, and FIG. 2 is a partially cut-out perspective view illustrating coupling relations of the main body (30) and the toolbar (40) of the automatic flange surface-machining apparatus (1) shown in FIG. 1.

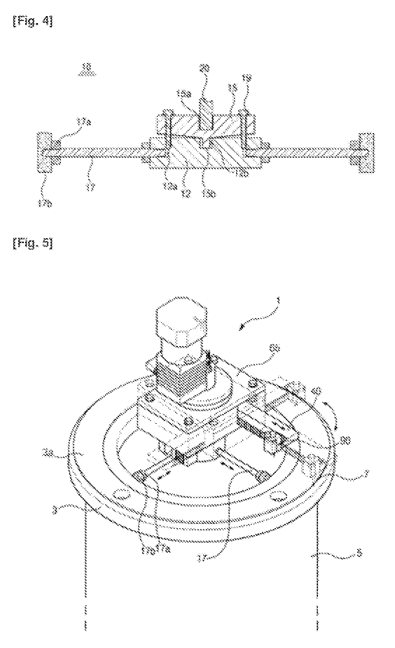

In addition, FIG. 3 is a exploded perspective view illustrating a flange surface-machining part (90) of the automatic flange surface-machining apparatus (1) shown in FIG. 1, FIG. 4 is a cross-sectional view illustrating a flange-fixing part shown in FIG. 1, and FIG. 5 is a view illustrating conditions for using the automatic flange surface-machining apparatus (1) shown in FIG. 1.

With reference to FIG. 1, the automatic flange surface-machining apparatus (1) according to a preferred example of the present invention comprises a flange-fixing part (10) fixed on the inner circumferential surface of a pipe (5) formed on a flange (3); a shaft (20) coupled with upper part of the flange-fixing part (10); a main body (30) in which is installed a guide protrusion (36) for providing a linear toolbar-guiding path (38) at one side thereof and a space communicating with the toolbar-guiding path (38) and penetrated by the shaft (20), and which is rotatably coupled with the shaft (20) penetrating the space; a toolbar (40) installed between the toolbar-guiding paths (38) so as to be moved along the toolbar-guiding path (38); a toolbar-feeding means installed in the main body (30) to feed the toolbar (40); an internal gear (60) coupled over the main body (30); a rotating motor base (70) installed over the internal gear (60) and fixed to the shaft; an internal gear-driving means (80) coupled with the rotating motor base (70) to rotate the internal gear (60); and a flange surface-machining part (90) installed on one side of the toolbar (40) to machine the flange surface (3a).

The flange-fixing part (10) is installed at lower part of the automatic flange surface-machining apparatus (1) to fix the automatic flange surface-machining apparatus on the inner circumferential surface of the pipe (5) formed at the flange (3), and consists of flange-fixing bolts (17), a chuck body (12) and a level block (15), description of which will follow.

The shaft (20) is fixed to a central portion of upper part of the flange-fixing part (10), i.e., the level block (15).

The shaft (20) is a rotation center for the automatic flange surface-machining apparatus (1), and the main body (30) is coupled with the shaft (20) while being penetrated thereby so that the main body can be rotated about the shaft (20), and the rotating motor base (70) over the main body (30) is fixed to the shaft (20).

The main body (30) rotatably coupled with the shaft (20) consists of a plane plate (32) and the guide protrusion (36) joined on upper surface of the plane plate (32)

The plane plate (32) forms a bottom surface of the main body (30), and at central portion of the plate is formed a through hole for enabling installation of the shaft (20) by penetration.

Furthermore, as illustrated in FIG. 1, on edge of the plane plate (32) are arranged a “ [symbol] ”-shaped guide protrusion (36a) for forming the space on the upper surface of the plane plate (32) and “l”-shaped guide protrusion (36b), thus the linear toolbar-guiding path (38) is formed between the “l”-shaped guide protrusion (36b) and the “ [symbol] ”-shaped guide protrusion (36a).

In such a linear toolbar-guiding path (38) is seated the toolbar (40) with which the flange surface-machining part (90) is coupled, and such a toolbar (40) is connected with the toolbar-feeding means so that the toolbar can be linearly moved between the linear toolbar-guiding paths (38). Such a toolbar-feeding means is installed in the space of the main body (30) and below the main body (30), detailed description of which will follow.

Furthermore, the internal gear (60) is coupled over the main body (30), i.e., a guide chuck.

The internal gear (60) is connected with the internal gear-driving means (80), which will be described in detail hereinafter, to rotate the main body (30) about the shaft (20), and gear teeth are formed on inner side of the internal gear.

Therefore, when the internal gear (60) is rotated about the shaft (20) which is rotatably coupled with the main body (30) while penetrating it, the main body (30) coupled with the internal gear (60) is caused to rotate about the shaft (20).

At this point, between the main body (30) and the internal gear (60) is installed a cover (65) for protecting the toolbar-feeding means installed in the space of the main body (30), at central portion of the cover being formed a through hole which is penetrated by the shaft (20), and the internal gear (60) is coupled with upper surface of the cover (65) with its center aligning with the through hole (66) of the cover (65).

Furthermore, on upper surface of the internal gear (60) is installed the rotating motor base (70) fixed to the shaft (20) which penetrates the cover (65).

The rotating motor base (70) is formed in shape of a cylindrical disk or a circular plate corresponding to the shape of the internal gear (60), and at central portion of the base is formed a through hole (71) which is penetrated by the shaft (20) for installation thereof, and the through hole (71) formed in the rotating motor base (70) and the shaft (20) are fixed by means of a separate fixing means (73).

Furthermore, between inner side of the internal gear (60) and the rotating motor base (70) is installed the internal gear-driving means (80) described hereinafter which rotates the internal gear (60) about the shaft (20),

Furthermore, on one side of the toolbar (40) fed along the toolbar-guiding path (38) of the main body (30) is installed the flange surface-maching part (90) for machining the flange surface (3a).

With reference to FIG. 2, the toolbar-feeding means will be described as follows.

The toolbar-feeding means for feeding the toolbar (40) in the toolbar guiding path (38) consists of a rack gear (52); a rack gear-driving part (54) comprising a feeding motor reducer (54a), a first feeding gear (54b), a second feeding gear (54c) and a third feeding gear (54d); and a feeding motor (56) for delivering power to the rack gear-driving part (54).

The rack gear (52) is installed on a side surface of the toolbar (40), in more particular, the side surface which faces the shaft installed in the main body (30), the rack gear-driving part consists of several gears meshing with the rack gear (52), and such gears are connected with the feeding motor (56) to feed the toolbar (40) between the toolbar-guiding paths (38) of the main body (30) according to driving of the feeding motor (56).

At this point, the feeding motor (56) is installed on a lower surface of the plane plate (32), and on rotational shaft of the feeding motor (56) is installed the feeding motor reducer (54a) for reducing rotational speed of the feeding motor (56) and changing rotational direction thereof, and on the plane plate (32) of the main body (30) is formed a feeding motor reducer-coupling hole which enables the rotational shaft of the feeding motor reducer (54a) to penetrate the space of the main body (30) for installation of the rotational shaft.

The first feeding gear (54b) is coupled with the rotational shaft of the feeding motor reducer (54a) located in the space through the feeding motor reducer-coupling hole, and the second feeding gear (54c) is installed while meshing with the first feeding gear (54b), and the third feeding gear (54d) rotatably coupled with the shaft (20) is installed while meshing with the second feeding gear (54c), and the rack gear (52) installed on the side surface of the toolbar (40) meshes with the second feeding gear (54c).

Therefore, rotational force of the feeding motor (56) is delivered to the toolbar (40) via the feeding motor reducer (54a), the first feeding gear (54b), the second feeding gear (54c), the third feeding gear (54d) and the rack gear (52), and the rack gear (52) is linearly moved by such rotational force inside the main body (30) along the toolbar-guiding path (38).

With reference to FIG. 1, the internal gear-driving means (80) will be described as follows.

The internal gear-driving means (80) consists of a rotational gear (82) meshing with the internal gear (60); a rotating motor reducer (84) for rotating the rotational gear (82); and a rotating motor (86).

The rotating motor reducer (84) and the rotating motor (86) are installed over the rotating motor base (70), and on the rotating motor base (70) is formed a rotating motor reducer-coupling hole (75) for enabling installation of the rotating motor reducer (84) so that the rotational shaft of the rotating motor reducer (84) can be located inside the internal gear (60).

The rotating motor reducer (84) is installed around the rotating motor reducer-coupling hole (75) so that the rotational shaft can be installed in the rotating motor reducer-coupling hole (75) while penetrating the hole, and the rotating motor (86) is installed at the rotating motor reducer (84).

Furthermore, the rotational gear (82) meshing with the internal gear (60) is installed on the rotational shaft of the rotating motor reducer (84) installed inside the internal gear (60).

Therefore, the rotational shaft of the rotating motor reducer (84) and the rotational gear (82) are rotated depending on rotation of the rotational shaft of the rotating motor (86), and the internal gear (60) meshing with the rotational gear (82) is rotated about the shaft (20), accordingly the cover (65) coupled with the internal gear (60) and the main body (30) are rotated about the shaft (20).

With reference to FIG. 3, the flange surface-machining part (90) will be described in detail as follows.

The flange surface-machining part (90) is coupled with one side of the toolbar (40) and machines the flange surface (3a) when the main body (30) is rotated about the shaft (20), and consists of a toolbar-coupling part (92), a bite-fixing part and bite-fixing part-feeding means (96).

The toolbar-coupling part (92) is a body of the flange surface-machining part (90), and consists of a support block (92a) on which are formed protrusions (92b) for providing a bite-fixing part-guiding path (92c) on front surface of the support block, a bracket (92d) formed on rear surface of the support block (92a) and coupled with one side of the toolbar (40), and a support block cover (92e) formed on upper surface of the support block (92a) and having a through hole (92f)

The protrusions (92b) formed on the front surface of the support block (92a) are formed on the both sides of the front surface of the support block (92a) in a longitudinal direction of the support block (92a) and provide the bite-fixing part-guiding path (92c) between the two protrusions (92b).

Furthermore, the bracket (92d) is projectedly formed on the rear surface of the support block (92a) in order to couple the one side of the toolbar (40) and the support block (92a), and fix the one side of the toolbar (40) and the support block (92a) by means of a separate fixing means.

Furthermore, the support block cover (92e) formed with the through hole (920 is formed on the upper surface of the support block (92a). At this point, threads are formed on inner circumferential surface of the through hole (92f), and this through hole communicates with the bite-fixing part-guiding path (92c).

The bite-fixing part (94) is a part on which a bite (94b) for machining the flange surface (3a) is fixed. and consists of a projected block (94c) inserted in the bite-fixing part-guiding path (92c) and constrained by the protrusions (92b), and a feeding block (94a) on which the bite (94b) is fixed.

The bite (94b) is coupled with the feeding block (94a) on lower part of the rear surface of the feeding block (94a) by means of a separate fixing means, and on upper part of the rear surface is formed a projected block (94c) which is formed in a shape corresponding to the bite fixing-part-guiding path (92c) and movable up-downward in the bite-fixing part-guiding path (92c).

At this point, a fixing hole (94d) is formed on upper surface of the projected block (94c) or the feeding block (94a) at a position corresponding to the through hole formed in the support block cover (92e).

The bite-fixing part-feeding means (96) is rotatably screwed in the through hole formed in the support block cover (92e), and consists of an operating shaft (96a) fixed in the fixing hole (94d) formed on upper surface of the projected block (94c) or the feeding block (94a) and a knob (96b) fixed on upper part of the operating shaft (96a).

The operating shaft (96a) has threads formed on its outer circumferential surface, and is screwed in the through hole (92f) formed in the support block cover (92e) and is moved up-downward along threads formed on inner circumferential surface of the through hole (92f) when the operating shaft (96a) is rotated in the through hole (92f) formed in the support block cover (92e).

At this point, the lower end part of the operating shaft (96a) is coupled with the fixing hole (94d) formed at the upper part of the feeding block (94a) or the projected block (94c) and moves the feeding block (94a) up-downward depending on the movement of the operating shaft (96a).

Therefore, when user rotates the knob (96b) to feed the operating shaft (96a) up-downward in the through hole (92f) of the support block cover (92e), the bite (94b) installed in the lower part of the feeding block (94a) is moved up-downward along the bite-fixing part-guiding path (92c) by feeding of the operating shaft (96a) with the projected block (94c) being inserted in the bite-fixing part-guiding path (92c), and thereby the height of the bite (94b) is adjusted.

Furthermore, an operating shaft-feeding gear (96c) is fixed on upper part of the operating shaft (96a), and at this point on upper surface of the support block cover (92e) is installed an operating shaft-driving motor reducer (96d) having an operating shaft-driving gear (96f) meshing with the operating shaft-feeding gear (96c), and an operating shaft-driving motor (96e) is connected with the operating shaft-driving motor reducer (96d) to drive the operating shaft-driving gear (96f) and the operating shaft-feeding gear (96c), thereby feeding the operating shaft (96a) up-downward through the support block cover (92e).

With reference to FIG. 4, the flange-fixing part (10) will be described as follows.

The flange-fixing part (10) comprises a chuck body (12), flange-fixing bolts (17) and a level block (15).

The chuck body (12) is formed in shape of a circular column, and on circumferential surface of the chuck body (12) are formed at angular interval of 90 degrees with center of the chuck body (12) being a reference flange-fixing bolt-coupling holes (12a) which are coupled with the flange-fixing bolts (17). Threads are formed on inner circumferential surfaces of the flange-fixing bolt-coupling holes (12a), and thus length of the flange-fixing bolts (17) from the circumferential surface of the chuck body (12) can be adjusted.

Furthermore, a recess (12b) is formed at central portion of the upper surface of the chuck body (12).

On one end parts of the flange-fixing bolts (17) are formed threads corresponding to the threads of the flange-fixing bolt-coupling hole (12a), and with the other end parts of the flange-fixing bolts are coupled cylindrical or hexagonal nuts (17a) which abut on inner circumferential surface of the pipe (5) formed at the flange (3) in larger area than the inner circumferential surface of the pipe.

At this point, cover (17b) of elastic material may be coupled with one end part of the nuts (17a) so that the other end part of the flange fixing bolts (17) is fixed on the inner circumferential surface of the pipe (5) and thus prevented from slipping.

The level block (15) adjusts horizontality of the main body (30) and fixes the shaft (20), and is formed in shape of a cylinder as a whole, and on upper surface of the level block is formed a coupling recess (15a) in which the shaft (20) is fixed, and bottom surface of the level block is downward convexly formed in shape of a cone so that the level block can be coupled with the chuck body (12) with angle being adjusted, and at central portion of the bottom surface is projectedly formed a projection (15b) which is inserted in recess (12b) formed at the central portion of the upper surface of the chuck body (12), and thus with the projection (15b) projectedly formed on the bottom surface of the level block (15) being inserted in the recess (12b) of the chuck body (12), the chuck body (12) and the level block (15) are fixed.

At this point, the bottom surface of the level block (15) is formed in shape of a cone, and the level block (15) and the chuck body (12) are fixed with angle between the recess (12b) and the projection (15b) being adjusted so that the upper surface of the level block (15) can be made horizontal with the flange surface (3a).

In the present example, through holes are formed in the chuck body (12) and the level block (15), and the chuck body (12) and the level block (15) are coupled by means of bolts (19) coupled with the through holes.

Furthermore, a separate controller (not illustrated in drawings) may be installed for the feeding motor (86), the rotating motor (86) and the operating shaft-driving motor (96e), and thus rotational direction and rotational speed of the feeding motor (56) for rotating the main body (30) can be controlled and rotational direction and rotational speed of the feeding motor (56) for feeding the toolbar (40) can be controlled.

At this point, on upper part of the shaft (20) may be installed a slip ring (22) for preventing wire and the like connected from the controller to each of the motors from being entangled when the main body (30) is rotated.

Furthermore, the operating shaft-driving motor (96e) can be controlled so as to control depth of the bite (94b), thereby controlling depth of serration (7) on the flange surface (3a).

At this point, the feeding motor (56) and the rotating motor (86) are controlled while being operatively connected.

When the circular plate-like serration (7) is formed by cutting the flange surface (3a), the feeding motor (56) and the rotating motor (86) should be operatively connected so that the flange surface-machining part (90) can be fed in the direction of the shaft or the opposite direction thereof depending on conditions of the flange surface (3a) which is cut according to rotation of the main body (30), and at this point the feed rate should be increased or decreased in reverse proportion to area cut by the bite (94b) abutting on the flange surface (3a).

In case that the area of the flange surface (3a) cut by the bite (94b) being fed is large, resistance between the bite (94b) and the flange surface (3a) is increased, and in case that the flange surface-machining part (90) is abruptly fed along with the toolbar (40), roughness of the serration (7) is not uniform and damage on the bite (94b) may be caused. Therefore, in such a case, the feed rate of the flange surface-machining part (90) should be controlled to be decreased.

Furthermore, in contrast, in case that the area of the flange surface (3a) cut by the bite (94b) is narrow, the roughness of the serration (7) becomes uniform if the flange surface-machining part (90) is slowly fed, but machining time is increased and thus work and energy efficiencies are reduced.

Therefore, in case that the feeding motor (56) and the rotating motor (86) are operatively connected depending on position of the flange surface-machining part (90) and the flange surface-machining part (90) is at long distance from the shaft (20), the flange surface-machining part (90) should be slowly fed by controlling the feeding motor (56), and in case that the flange surface-machining part (90) is at short distance from the shaft (20), the feeding motor (56) should be controlled so that the flange surface-machining part (90) can be quickly fed.

Furthermore, the controller may adjust the depth of the bite (94b) by being also operatively connected with the operating shaft-driving motor.

The resistance generated according to the area of the cut surface can be adjusted by means of the feed rate of the flange surface-machining part (90), but can be also controlled by adjusting the position of the bite (94b) abutting on the flange surface (3a).

Therefore, the controller can be operatively connected with the feeding motor (56), the rotating motor (86) and the operating shaft-driving motor (96e) so as to adjust the feed rate of the flange surface-machining part (90) and the depth of the bite (94b) according to the position of the flange surface-machining part (90).

Furthermore, the controller may control the feeding motor (56), the rotating motor (86) and the operating shaft-driving motor (96e) according to predetermined programs, but also may control each of the motors separately.

With reference to FIG. 5, conditions and methods for using the automatic flange surface-machining apparatus (1) according to a preferred example of the present invention will be described as follows.

The chuck body (12) of the automatic flange surface-machining apparatus (1) is fixed on the inner circumferential surface of the pipe (5) by means of the flange-fixing bolts (17). At this point, the chuck body (12) is fixed with the length of the flange-fixing bolts (17) from the circumferential surface of the chuck body (12) being adjusted so that the recess (12b) of the chuck body (12) can be positioned at center of the pipe (5).

If the chuck body (12) is fixed in the pipe (5), the level block (15) is installed over the chuck body (12), and at that time the chuck body (12) and the level block (15) are fixed with the angle between the recess (12b) of the chuck body (12) and the projection (15b) of the level block (15) being adjusted so that the upper surface of the level block (15) can be made horizontal with the flange surface (3a).

If the level block (15) and the chuck body (12) are coupled with each other, the shaft (20) coupled with the main body (30) is fixed in the coupling recess (15a) of the level block (15) and the position of the flange surface-machining part (90) and the depth of the bite (94b) are adjusted by means of the controller, and the rotating motor (86) is controlled to rotate the main body (30), thereby machining the flange surface (3a).

At this point, the rotating motor (86), the feeding motor (56) and the operating shaft-driving motor (96e) can be operatively connected with each other to be fed according to variation of position of the flange surface-machining part (90), and at this point for each of the rotating motor (86), the feeding motor (56) and the operating shaft-driving motor (96e) is installed a controlling part which measures the position of the flange surface-machining part (90) and external force applied to the bite (94b) to control the motors, and such a controlling part may control the three motors while operatively connecting them, or control each of the motors separately.

In the present example, various motors may be used for the rotating motor (86), the feeding motor (56) and the operating shaft-driving motor (96e), but it is preferred to use servo motors which can be precisely controlled and have quick and speed-variable response characteristics.

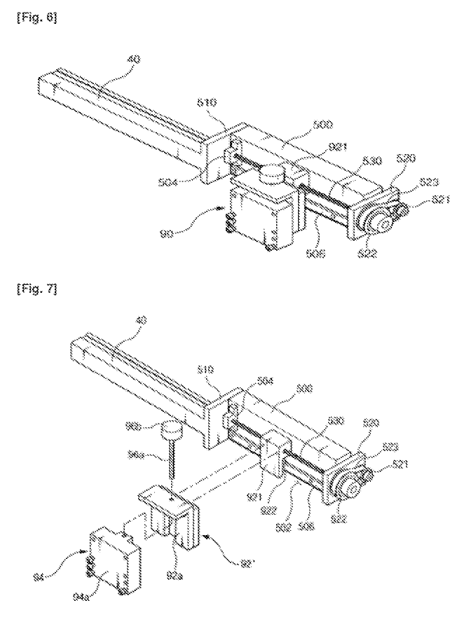

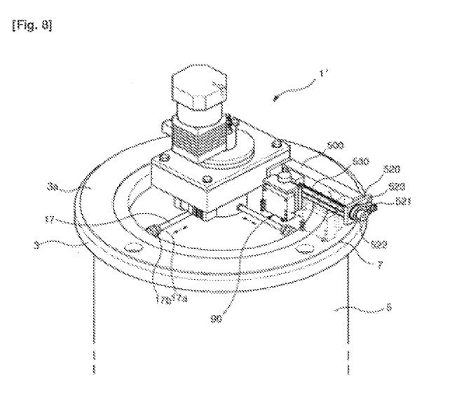

Meanwhile, FIGS. 6 to 8 illustrate another example of the present invention, wherein FIG. 6 is a perspective view illustrating a feeding motor-receiving part coupled with the toolbar according to the another example of the present invention, FIG. 7 is a exploded perspective view of FIG. 6, and FIG. 8 is a view illustrating conditions for using automatic flange surface-machining apparatus according to the another example of the present invention,

General constructions of the automatic flange surface-machining apparatus (1′) according to the another example of the present invention is similar to the previous example, therefore same constituents are denoted by same reference numerals.

However, the two examples are different from each other in that, in the previous example, the toolbar (40) is installed so that it can be moved along the toolbar-guiding path (38) of the main body (30), and the toolbar (40) is moved by means of the toolbar-feeding means installed in the main body (30), and thus the position of the flange surface-machining part (90) fixedly installed on the one side of the toolbar (40) can be adjusted, while in the another example of the present invention, the toolbar (40) is seated and fixed in the toolbar-guiding path (38) of the main body (30), and the flange surface-machining part (90) is installed on one side of the toolbar (40) so that the part itself can linearly move, and thus the position of the flange surface-machining part (90) can be adjusted by means of the movement of the part itself.

As illustrated in FIGS. 6 and 7, in the automatic flange surface-machining apparatus (1′) according to the another example of the present invention, the toolbar (40) is seated in the toolbar guiding path (38) of the main body (30), and with one side of the toolbar (40) is coupled a first bracket (510), which is supported on one side of the main body (30), and one end part of the feeding motor-receiving part (500) in shape of rectangular parallelepiped is coupled with one side of the first bracket (510).

Furthermore, an opening part is formed by cut in predetermined depth at one side of the rear surface of the feeding motor-receiving part (500), and the feeding motor (not illustrated in the drawings) is inserted and installed in the opening part, and a second bracket (520) is coupled with the other end part of the feeding motor-receiving part (500), and on outer side of the second bracket (520) are installed a driving pulley (521) rotated by the feeding motor, and follower motor (522) located at a predetermined distance from the driving pulley (521) and rotated by a timing belt (523) while being operatively connected with driving pulley (521).

At this point, the first bracket (510) and the second bracket (520) are coupled with the both sides of the feeding motor-receiving part (500), and front end parts of the first bracket (510) and the second bracket (520) are protruded to the front of the feeding motor-receiving part (500), and thereby in front of the feeding motor-receiving part (500) is formed a space partitioned by the first bracket (510) and the second bracket (520), and a feeding shaft (530) is installed in the space.

That is to say, the feeding shaft (530) having threads on its outer circumferential surface is installed parallel with the feeding motor-receiving part (500) at a distance therefrom in front of the feeding motor-receiving part (500), and one end part of the feeding shaft (530) is rotatably coupled with the second bracket (520) and coupled with the follower pulley (522) at its end, and the other end part of the feeding shaft (530) is rotatably coupled with a supporting part (504) which is provided at a predetermined distance from the first bracket (510) on one side of the front surface of the feeding motor-receiving part (500),

At this point, one side of the flange surface-machining part (90) is screwed to the feeding shaft (530), and the flange surface-machining part (90) is moved along the feeding shaft (530) by means of operation of the feeding motor, and in the previous example the support block (92a) of the toolbar-coupling part (92) is coupled with one side of the toolbar (40) by means of the bracket (92d), while in the another example of the present invention, as illustrated in FIG. 6, the feeding shaft (530) is screwed to a right-leftward feeding block (921) while penetrating the block, the right-leftward feeding block being coupled with rear surface of a support block (92a) of a feeding shaft-coupling part (92′).

At this point, in order to guide direction of movement of the flange surface-machining part (90), a guide rail (506) is installed parallel with the feeding shaft (530) on lower end part of the front surface of the feeding motor-receiving part (500), and at lower end part of the right/leftward feeding block (921) is provided a corresponding guide part (922) which is coupled with the guide rail (506).

Therefore, if the driving pulley (521) is rotated by means of the operation of the feeding motor, driving power is transferred to the follower pulley (522) by the timing belt (523), thereby causing the follower pulley to rotate, and the feeding shaft (530) is rotated along with the follower pulley (522), and as illustrated in FIG. 8, the right-leftward feeding block (921) screwed to the feeding shaft (530) is moved along the guide rail (506), and thereby the position of the flange surface-machining part (90) can be adjusted, and at this point the operation of the feeding motor can be also controlled by means of the controller, as in the previous example.

### INDUSTRIAL APPLICABILITY

In the automatic flange surface-machining apparatus constructed as above according to the present invention, the bite for machining serration on the flange surface is horizontally moved in the main body and rotated and is driven up-downward according to depth of the serration, therefore uniform roughness of the serration is obtained, and the serration can be machined with accurate position and rotational speed by connecting controller to each of the driving parts, and the whole size and weight of the apparatus can be reduced by carrying out horizontal, up-downward and rotational movement by means of motors.

1. An automatic flange surface-machining apparatus characterized in that it comprises:
a flange-fixing part fixed on the inner circumferential surface of a pipe formed on a flange;
a shaft coupled with upper part of the flange-fixing part;
a main body in which is installed a guide protrusion for providing a linear toolbar-guiding path at one side thereof and a space communicating with the toolbar-guiding path and penetrated by the shaft, and which is rotatably coupled with the shaft penetrating the space;
a toolbar installed between the toolbar-guiding path so as to be moved along the toolbar-guiding path;
a toolbar-feeding means installed in the main body to feed the toolbar;
an internal gear coupled over the main body;
a rotating motor base installed over the internal gear and fixed to the shaft;
an internal gear-driving means coupled with the rotating motor base to rotate the internal gear; and
a flange surface-machining part installed on one side of the toolbar to machine the flange surface.

2. The automatic flange surface-machining apparatus according to claim 1, characterized in that the toolbar-feeding means comprises a rack gear installed on the side surface of the toolbar facing the space; a rack gear-driving part consisting of several gears for driving the rack gear while meshing with the rack gear; and a feeding motor which is installed on the main body and delivers power to the rack gear-driving part.

3. The automatic flange surface machining apparatus according to claim 2, characterized in that the rack gear-driving part comprises a feeding motor reducer which is installed on bottom surface of the main body and coupled so that its rotational shaft penetrates the space; a first feeding gear coupled with the rotational shaft of the feeding motor reducer; a second feeding gear installed while meshing with the first feeding gear; and a third feeding gear which is rotatably coupled with the shaft penetrating the space and meshes with the second feeding gear and the rack gear to deliver rotational force of the second feeding gear to the rack gear, and the feeding motor is connected with the feeding motor reducer to drive the rotational shaft of the feeding motor reducer.

4. The automatic flange surface machining apparatus according to claim 1, characterized in that the internal gear is coupled with the main body so that the internal gear can be rotated about the shaft coupled while penetrating the main body, and the internal gear-driving means comprises a rotating motor reducer which is installed over the rotating motor base and rotational shaft of which is located in the space; a rotational gear coupled with the rotational shaft of the rotating motor reducer and meshing with the internal gear; and a rotating motor connected with the rotating motor reducer to drive the rotational shaft of the rotating motor reducer.

5. The automatic flange surface machining apparatus according to claim 1, characterized in that the flange surface-maching part comprises a toolbar-coupling part coupled with one side of the toolbar; a bite-fixing part which is coupled with front surface of the toolbar-coupling part so that the bite-fixing part can be linearly moved in height direction of the toolbar-coupling part, and is equipped with a bite for cutting the flange surface; and a bite-fixing part-feeding means which is screwed between the toolbar-coupling part and the bite-fixing part to move the bite-fixing part.

6. The automatic flange surface machining apparatus according to claim 5, characterized in that the toolbar-coupling part comprise a support block on which are formed protrusions for providing a linear bite-fixing part-guiding path extending in the height direction of the support block on one side of front surface thereof; a bracket formed on rear surface of the support block and coupled with the toolbar; and a support block cover arranged on upper surface of the support block and formed with a through hole so that the bite-fixing part-feeding means can be rotatably coupled with the cover, and
the bite-fixing part comprises a feeding block formed with a projected block which is inserted in the bite-fixing part-guiding path and linearly movable along the bite-fixing part-guiding path; and a bite which is coupled with lower part of the feeding block to cut the flange surface, and
the bite-fixing part-feeding means comprises an operating shaft which is screwed to upper part of the feeding block through the through hole of the support block cover and feeds the feeding block along the bite-fixing part-guiding path while rotated; and a knob provided on upper part of the operating shaft.

7. The automatic flange surface machining apparatus according to claim 6, characterized in that an operating shaft-feeding gear is coupled with upper part of the operating shaft, an operating shaft-driving motor is installed on upper surface of the support block cover, and on rotational shaft of the operating shaft-driving motor is installed an operating shaft-driving motor reducer for delivering rotational force to the operating shaft-feeding gear.

8. The automatic flange surface machining apparatus according to claim 1, characterized in that the flange-fixing part further comprises a chuck including a chuck body which is formed with a recess at central portion of upper surface of the chuck body and is formed in shape of a circular column, and flange-fixing bolts which are screwed to circumferential surface of the chuck body and movable perpendicular to the circumferential surface; a level block which is formed in shape of a circular column and formed with a coupling recess coupled with the shaft at central portion of the upper surface of the level block, and bottom surface of which is convexly formed in shape of a cone and has a projection, which is coupled with the recess, formed at its central portion; and a fixing means for fixing the chuck body and the level block.

9. An automatic flange surface-machining apparatus characterized in that it comprises:
a flange-fixing part fixed on the internal surface of a pipe formed on a flange;
a shaft coupled with upper part of the flange-fixing part;
a main body in which is installed a guide protrusion for providing a linear toolbar-guiding path at one side thereof and a space communicating with the toolbar-guiding path and penetrated by the shaft, and which is rotatably coupled with the shaft penetrating the space;
a toolbar supported between the toolbar-guiding paths;
an internal gear coupled over the main body;
a rotating motor base installed over the internal gear and fixed to the shaft;
an internal gear-driving means coupled with the rotating motor base to rotate the internal gear, and
a flange surface-machining part installed on one side of the toolbar so as to be linearly movable to machine the flange surface.

10. The automatic flange surface machining apparatus according to claim 9, characterized in that a feeding motor-receiving part is coupled with one side of the toolbar, a feeding shaft having threads on its outer circumferential surface is installed in front of the feeding motor-receiving part with a distance therefrom, and one side of the flange surface-coaching part is screwed to the feeding shaft.

11. The automatic flange surface machining apparatus according to claim 10, characterized in that a feeding motor is provided at one side of the feeding motor-receiving part, and the feeding shaft is rotated while being operatively connected with the operation of the feeding motor, and thereby the flange surface-coaching part can be linearly moved along the feeding shaft.

12. The automatic flange surface machining apparatus according to claim 9, characterized in that the internal gear is coupled with the main body so that the internal gear can be rotated about the shaft coupled while penetrating the main body, and the internal gear-driving means comprises a rotating motor reducer which is installed over the rotating motor base and rotational shaft of which is located in the space; a rotational gear coupled with the rotational shaft of the rotating motor reducer and meshing with the internal gear; and a rotating motor connected with the rotating motor reducer to drive the rotational shaft of the rotating motor reducer.

13. The automatic flange surface machining apparatus according to claim 10, characterized in that the flange surface-maching part comprises a feeding shaft-coupling part whose one side is screwed to the feeding shaft; a bite-fixing part which is coupled with front surface of the feeding shaft-coupling part so that the bite-fixing part can be linearly moved in height direction of the feeding shaft-coupling part, and is equipped with a bite for cutting the flange surface; and a bite-fixing part-feeding means which is screwed between the feeding shaft-coupling part and the bite-fixing part to move the bite-fixing part.

14. The automatic flange surface machining apparatus according to claim 13, characterized in that the feeding shaft-coupling part comprise a support block on which are formed protrusions for providing a linear bite-fixing part-guiding path extending in the height direction of the support block on one side of front surface thereof; a right-leftward feeding block formed on rear surface of the support block and screwed to the feeding shaft; and a support block cover arranged on upper surface of the support block and formed with a through hole so that the bite-fixing part-feeding means can be rotatably coupled with the cover, and
the bite-fixing part comprises a up-downward feeding block formed with a projected block which is inserted in the bite-fixing part-guiding path and linearly movable along the bite-fixing part-guiding path; and a bite which is coupled with lower part of the up-downward feeding block to cut the flange surface, and
the bite-fixing part-feeding means comprises an operating shaft which is screwed to upper part of the up-downward feeding block through the through hole of the support block cover and feeds the up-downward feeding block along the bite-fixing part-guiding path while rotated; and a knob provided on upper part of the operating shaft.

15. The automatic flange surface machining apparatus according to claim 9, characterized in that the flange-fixing part further comprises a chuck including a chuck body which is formed with a recess at central portion of upper surface of the chuck body and is formed in shape of a circular column, and flange-fixing bolts which are screwed to circumferential surface of the chuck body and movable perpendicular to the circumferential surface; a level block which is formed in shape of a circular column and formed with a coupling recess coupled with the shaft at central portion of the upper surface of the level block, and bottom surface of which is convexly formed in shape of a cone and has a projection, which is coupled with the recess, formed at its central portion; and a fixing means for fixing the chuck body and the level block.
